(19) United States
(12) Patent Application Publication
(10) Pub. No.: US 2024/0255651 A1
(43) Pub. Date: Aug. 1, 2024

(54) ENHANCEMENTS ON SATELLITE POSITIONING MEASUREMENT

(71) Applicant: Nokia Technologies Oy, Espoo (FI)

(72) Inventors: Jing Yuan SUN, Beijing (CN); Ping YUAN, Beijing (CN)

(21) Appl. No.: 18/560,851

(22) PCT Filed: May 18, 2021
(86) PCT No.: PCT/CN2021/094462

§ 371 Date: Nov. 14, 2023

(51) Int. Cl. G01S 19/24; H04W 64/00

(52) U.S. Cl. CPC G01S 19/24; H04W 64/00

(57) ABSTRACT

Example embodiments of the present disclosure relate to devices, methods, apparatuses and computer readable storage media of satellite positioning measurement. The method comprises: transmitting, at a first device and to a second device serving the first device, a first message for indicating a first configuration of a window for satellite positioning; and communicating with the second device based on the window determined according to the first configuration. In this way, the configuration of the window for satellite positioning can be aligned between the UE and the base station with a low signaling overhead.

### FIELD

Embodiments of the present disclosure generally relate to the field of telecommunication and in particular, to devices, methods, apparatus and computer readable storage media of enhancements on satellite positioning measurement.

### BACKGROUND

Non terrestrial networks (NTNs) are utilized for providing an extended network coverage, which facilitates the communications between earth stations, such as, terminal devices, base stations (BS) and the like. In addition to acting as a relay, the NTNs also provide various services. For example, the global navigation satellite system (GNSS) has been widely used for positioning the terminal devices. The NTN has been developed to support narrow band Internet of things (NB-IoT) and enhanced machine type communication (eMTC).

In the NB-IoT or eMTC scenarios, the terminal device is assumed to be able to estimate and pre-compensate timing and frequency offset based on GNSS information of the terminal device and the satellite's ephemeris information and velocity information. For NB-IoT or eMTC terminal devices, as a low cost, complexity and reduced power consumption are required, half-duplex operation is considered and utilized. In the half-duplex mode, uplink (UL) and downlink (DL) operations are not performed at same time. Furthermore, the terminal device performs GNSS measurements, meanwhile UL and DL operations are not assumed to be performed between the terminal device and the serving base station.

### SUMMARY

In general, example embodiments of the present disclosure provide a solution of enhancements on satellite positioning measurement.

In a first aspect, there is provided a first device. The first device comprises at least one processor; and at least one memory including computer program codes; the at least one memory and the computer program codes are configured to, with the at least one processor, cause the first device at least to: transmit, to a second device serving the first device, a first message for indicating a first configuration of a window for satellite positioning; and communicate with the second device based on the window determined according to the first configuration.

In a second aspect, there is provided a second device. The second device comprises at least one processor; and at least one memory including computer program codes; the at least one memory and the computer program codes are configured to, with the at least one processor, cause the second device at least to: receive, from a first device, a first message for indicating a first configuration of a window for satellite positioning; and communicate with the first device based on the window determined according to the first configuration.

In a third aspect, there is provided a method. The method comprises: transmitting, at a first device and to a second device serving the first device, a first message for indicating a first configuration of a window for satellite positioning; and communicating with the second device based on the window determined according to the first configuration.

In a fourth aspect, there is provided a method. The method comprises: receiving, at a second device and from a first device, a first message for indicating a first configuration of a window for satellite positioning; and communicating with the first device based on the window determined according to the first configuration.

In a fifth aspect, there is provided a first apparatus comprising: means for transmitting, to a second device serving the first device, a first message for indicating a first configuration of a window for satellite positioning; and means for communicating with the second device based on the window determined according to the first configuration.

In a sixth aspect, there is provided a second apparatus comprising: means for receiving, from a first device, a first message for indicating a first configuration of a window for satellite positioning; and means for communicating with the first device based on the window determined according to the first configuration.

In a seventh aspect, there is provided a computer readable medium having a computer program stored thereon which, when executed by at least one processor of a device, causes the device to carry out the method according to the third aspect.

In an eighth aspect, there is provided a computer readable medium having a computer program stored thereon which, when executed by at least one processor of a device, causes the device to carry out the method according to the fourth aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 illustrates an example communication network in which example embodiments of the present disclosure can be implemented;

FIG. 2 shows a signaling chart illustrating a process of satellite positioning measurement according to some example embodiments of the present disclosure;

FIG. 3 illustrates a schematic diagram of a relationship between measurement capability of the terminal device and the maximum measurement time requested by the terminal device according to some example embodiments of the present disclosure;

FIG. 4 illustrates a schematic diagram of a relationship between GNSS channel quality and the maximum measurement time requested by the terminal device according to some example embodiments of the present disclosure;

FIG. 5 illustrates a flowchart of an example method of satellite positioning measurement according to some example embodiments of the present disclosure;

FIG. 6 illustrates a flowchart of an example method of satellite positioning measurement according to some example embodiments of the present disclosure

FIG. 7 is a simplified block diagram of a device that is suitable for implementing embodiments of the present disclosure; and

FIG. 8 illustrates a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/of” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

The NTN is capable of providing a wide network coverage and facilitating communication between the user equipment (UE) with large coupling loss or large pathloss and the base station (e.g., gNB). To provide such a wide coverage, the base station may configure respective numbers of repetitions for UEs with different coupling losses, so that enough repetitions of data are transmitted to the UEs or received from the UEs. This provides corresponding gains requested to compensate the corresponding coupling losses of the UEs.

In the NTN, the UEs may perform GNSS measurements within respective GNSS measurement windows, and the UEs may vary from time required for measuring the GNSS signal. Specifically, the UEs having different capabilities for acquiring position information from the GNSS may require different sizes of GNSS measurement window. For example, the UE with 2 receiving antennas for receipt of GNSS signal provides more antenna gain than the UE with 1 receiving antenna, and thus the UE with 2 receiving antennas may require less time for GNSS measurement than the UE with 1 receiving antenna. A higher UE GNSS measurement capability, e.g. more number of antenna to receive GNSS signal, can provide more GNSS receiving gain and faster GNSS measurement, while a lower UE GNSS measurement capability, e.g. less number of antenna to receive GNSS signal can provide less GNSS receiving gain and slower GNSS measurement.

However, a fixed size of GNSS measurement window may not be suitable for a specific UE. For example, the size of GNSS measurement window required by the UE may depend on the environment where the UE is located, since different noise levels or different reflection/multi-paths would impact a carrier to noise ratio, which is denoted by C/NO. The UE experiencing a poor GNSS measurement quality may require more time for GNSS measurement than the UE experiencing a good GNSS measurement quality. For example, the UE in vegetation area with some sheltering may experience a worse GNSS channel status as compared with the UE in an outdoor environment without sheltering. Thus, in this example, the former UE may require more time to achieve a stable GNSS measurement result.

Further, the GNSS channel status may change along with UE's movement. In this case, the size of GNSS measurement window required by the UE may also change. For example, when the UE moves from an area without any shelter to an area with some shelters to the UE, more time may be required by the UE for measuring a GNSS signal accurately.

During the GNSS measurement window, the UE and the base station are prevented from UL and DL transmissions. In a legacy network system, a fixed gap is defined for DL synchronization in a case where UE is configured for Physical Random Access Channel (PRACH) repetitions or Physical Uplink Shared Channel (PUSCH) repetitions. For example, for an IoT UE operating in the half duplex mode, after transmissions and/or postponements due to Narrow Band Physical Random Access Channel (NPRACH) of 256·30720 T_{S} time units, for frame structure type 1, a gap of 40·30720 T_{S} time units shall be inserted where the Narrow Band Physical Uplink Shared Channel (NPUSCH) transmission is postponed. The portion of a postponement due to NPRACH which coincides with a gap is counted as part of the gap. However, such a fixed gap defined for the UL transmission cannot satisfy different requirements for GNSS measurement window.

Therefore, different measurement gaps should be supported at the UE for GNSS measurement. For example, for an IoT UE with a large coupling loss, channel repetitions may be configured for UL and DL transmissions. During the data transmission with the channel repetitions, if the GNSS channel status changes when UE is moving, the gap for GNSS measurement should be synchronized between the UE and base station. Otherwise, the base station would not know how many repetitions UE might postpone or skip. This may further cause the base station to be unable to consider the repetition postpone or skip in determining the timing of a next scheduling or a number of repetitions for the UE.

In order to solve the above and other potential problems, embodiments of the present disclosure provide an effective mechanism for supporting a flexibly configured measurement window. With such a mechanism, a fast alignment on the measurement window can be reached between the UE and the base station. Further, the mechanism may satisfy the requirements on a reduced cost, complexity and power consumption of the UE as well as a low signaling overhead and latency.

Example embodiments of the present disclosure will be described in detail below with reference to the accompanying drawings. Principle and embodiments of the present disclosure will be described in detail below with reference to the accompanying drawings.

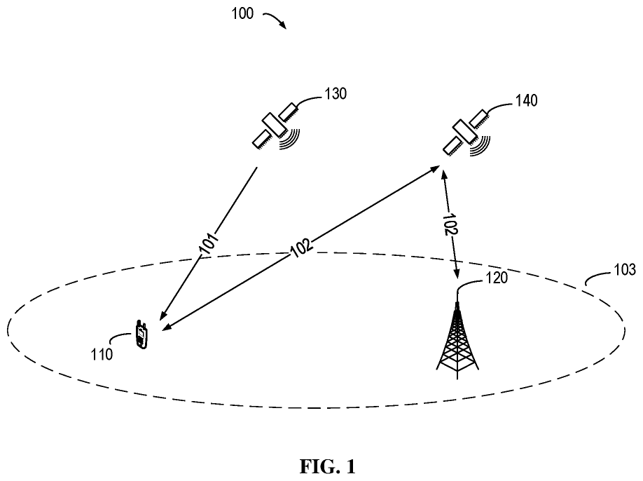

FIG. 1 shows an example communication network 100 in which embodiments of the present disclosure can be implemented. As shown in FIG. 1, the communication network 100 may be an NTN which includes a first device 110, a second device 120, a first NTN device 130 and a second NTN device 140.

The first device 110 may communicate with the first NTN device 130 via a first channel 101 for acquiring position information of the first device. For example, the first device 110 may be configured with a GNSS measurement window during which time the first device 110 measures a GNSS signal from the first NTN device 130 for acquiring the position information. The first device 110 may transmit a measurement report for satellite positioning to the second device 120.

Depending on the measurement capability and/or a channel status of a channel experienced by the first device 110, the first device 110 may require a different size of the GNSS measurement window. The channel may be the first channel 101 or the second channel 102. It should be understood that in the context of the present disclosure, the GNSS, the GNSS signal, and GNSS measurement window are given for illustrative purpose only, and any other satellite positioning system and technology are also suitable for implementation of the example embodiments. The present disclosure is not limited in this regard.

The first device 110 (hereinafter may also be referred to as a terminal device 110 or a UE 110) is located within a coverage 103 provided by the second NTN device 140 for facilitating the communication between the first device 110 and the second device 120. Specifically, the data transmission between the first device 110 and the second device 120 may be relayed through the second NTN device 120. As shown in FIG. 1, a second channel 102 for data transmission may contain a first portion between the first device 110 and the second NTN device 140, and a second portion between the second NTN device 140 and the second device 140. In the context of the present disclosure, the second channel 102 may include the DL and/or UL channels between the first device 110 and the second device 120. In some cases, the second channel 102 may only refer to the first portion between the first device 110 and the second NTN device 140.

The second device 120 (hereinafter may also be referred to as a network device 120 or a gNB 120) serves the first device 110. The second device 120 may transmit candidate configurations about the GNSS measurement window to the first device 110, for example, via a radio resource control message. The candidate configurations may be but not limited to at least one of a candidate window size, a candidate periodicity, a candidate offset, a candidate starting time of the GNSS measurement window and son on. The candidate configuration may be in the form of a table or item(s) from a table, where each item include, but not limited to, at least one of a candidate window size, a candidate periodicity, a candidate offset, a candidate starting time of the GNSS measurement window and son on. Additionally, or alternatively, the candidate configurations about the GNSS measurement window may be predefined at the first device 110 and the second device 120.

The first device 110 may select a first configuration from the candidate configurations and transmit a first message for indicating the first configuration to second device 120. The selection of the first configuration may be based on, for example, the measurement capability, and/or the channel status of the first channel 101 or the second channel 102, a moving speed of the first device 110, a system frame number received from the second deice 120, a time for last transmission of the first message, a starting or end position of a last window for satellite positioning and so on, which will be discussed in details below.

The second device 120 may be aware of the first configuration of the GNSS measurement window upon receipt of the first message. The second device 120 may then communicate with first device 110 based on the window determined according to the first configuration. For example, the second device 120 may avoid transmit or receive data transmission to or from the first device 110 during the GNSS measurement window.

In some cases, the second device 120 may further determine a second configuration of the GNSS measurement window based on the first configuration, and transmit a second message for indicating the second configuration. In these cases, the second device 120 may communicate with the first device 110 based on the window of the second configuration.

Likewise, the first device 110 can also acquire position information of the second NTN device 140 from the second NTN device 140 according to the window for satellite positioning. The communication may be synchronized between the first device 110 and the second NTN device 140 based on the acquired position information from the second NTN device 140.

The first NTN device 130 may provide positioning service to the earth stations including the first device 110 and the second device 120. The first NTN device 130 may include, but not limited to a satellite supporting the GNSS. The second NTN device 140 may provide coverage enhancement and relay functions.

It is to be understood that the number of terminal devices and network devices are only for the purpose of illustration without suggesting any limitations. The communication network 100 may include any suitable number of terminal devices adapted for implementing embodiments of the present disclosure.

Only for ease of discussion, the first device 110 is illustrated as a UE, the second device 120 is illustrated as a base station, and the first NTN device 130 and the second NTN device 140 are illustrated as satellites. It is to be understood that the UE, the base station and the satellite are only example implementations of the first device 110, the second device 120, the first NTN device 130 and the second NTN device 140 respectively, without suggesting any limitation as to the scope of the present application. Any other suitable implementations are possible as well.

Depending on the communication technologies, the network 100 may be a Code Division Multiple Access (CDMA) network, a Time Division Multiple Address (TDMA) network, a Frequency Division Multiple Access (FDMA) network, an Orthogonal Frequency-Division Multiple Access (OFDMA) network, a Single Carrier-Frequency Division Multiple Access (SC-FDMA) network or any others. Communications discussed in the network 100 may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols. The techniques described herein may be used for the wireless networks and radio technologies mentioned above as well as other wireless networks and radio technologies. For clarity, certain aspects of the techniques are described below for LTE, and LTE terminology is used in much of the description below.

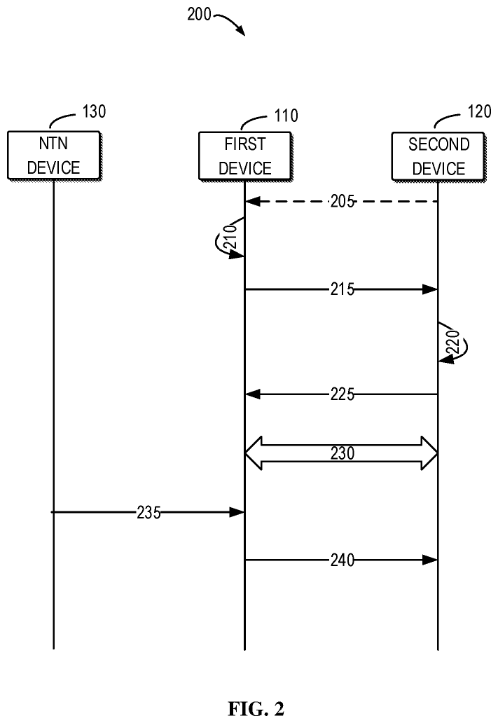

Principle and implementations of the present disclosure will be described in detail below with reference to FIG. 2. FIG. 2 shows a signaling chart illustrating a process 200 of satellite positioning measurement according to some example embodiments of the present disclosure. For the purpose of discussion, the process 200 will be described with reference to FIG. 1. The process 200 may involve the first device 110, the second device 120 and the first NTN device 130.

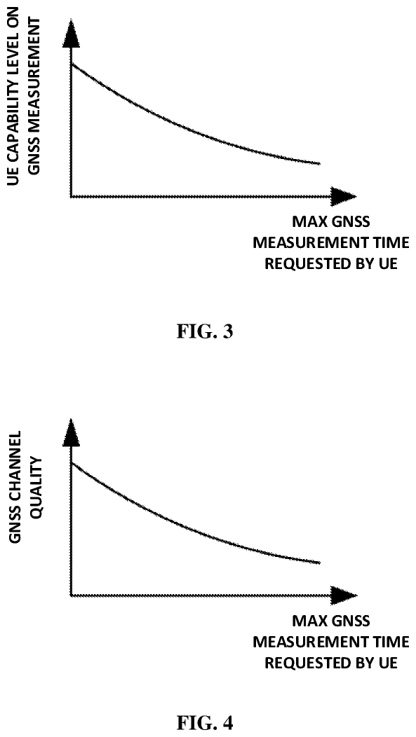

As shown in FIG. 3, the second device 120 may transmit 205 a set of candidate configurations of a window for satellite positioning to the first device 110. Alternatively, the set of candidate configurations of the window may be predefined at the first device 110 and the second device 120. In some example embodiments, the set of candidate configurations may be indexed and included in a table.

In some example embodiments, the set of candidate configurations may include, but not limited to, at least one of candidate window sizes, candidate periodicities, candidate offsets, candidate starting times of the window.

The first device 110 may determine 210 a first configuration of the window for satellite positioning from the set of candidate configurations.

In some example embodiments, the first configuration may be determined based on a capability of the first device 110 to acquire position information. By way of example, the capability of the first device 110 to acquire position information may refer to the measurement capability of the first device 110 in measuring the GNSS signal. By way of example, the capability may be evaluated by a number of receiving antennas.

The first configuration may include at least one of a window size, an offset, a periodicity or a starting time of the window required by the first device 110 for acquiring position information. For example, the window size may be determined to be the maximum window size requested by the first device 110. For another example, the periodicity of the window may be determined to be the minimum periodicity requested by the first device 110.

FIG. 3 illustrates a schematic diagram of a relationship between measurement capability of the terminal device and the maximum measurement time requested by the terminal device according to some example embodiments of the present disclosure. As shown in FIG. 3, the higher the capability in terms of GNSS measurement, for example, the more receiving antennas there is, which in turn provide more GNSS receiving gain and a faster GNSS measurement, the smaller maximum GNSS measurement time the terminal device requires, while the lower the capability in terms of GNSS measurement, for example, the less receiving antennas there is, which in turn provide less GNSS receiving gain and a slower GNSS measurement, the larger maximum GNSS measurement time the terminal device requires.

In some example embodiments, the first configuration may be determined based on a channel status of a channel experienced by the first device 110. The channel may be a GNSS based channel, such as, the first channel 101 between the first device 110 and the first NTN device 130, or alternatively a wireless network channel, such as, the second channel 102 between the first device 110 and the second device 120. In a case where the first device 110 may not be able to collect or report the GNSS based channel status, the first device 110 may take the channel status of the second channel 102 into consideration for reference.

By way of example, the channel status may be evaluated by at least one of a propagation delay of a signal transmitted in the channel, a doppler shift of signal transmitted the channel, at least one parameter indicating a quality of the channel, such as, RSRP, RSRQ associated with the channel, or a changing rate of the channel.

For example, a higher changing rate of the first channel 101 may cause the first device 110 to require a larger GNSS measurement period to update the GNSS measurement. While a lower changing rate of the first channel 101 may cause the first device 110 to require a smaller GNSS measurement period to update the GNSS measurement.

FIG. 4 illustrates a schematic diagram of a relationship between GNSS channel quality and the maximum GNSS measurement time requested by the terminal device according to some example embodiments of the present disclosure. As shown in FIG. 4, the higher the GNSS channel quality, the smaller maximum GNSS measurement time the terminal device requires, while the lower the GNSS channel quality, the larger maximum GNSS measurement time the terminal device requires.

In some example embodiments, the first configuration may be determined further based on at least one of a moving speed of the first device 110, a system frame number received from the second device 120, a time for last transmission of a first message, a starting or end position of a last window for satellite positioning. The first message may be configured for indicating a target configuration selected by the first device 110, such as, the first configuration.

In some example embodiments, the periodicity or the offset of the window requested by the first device 110 may be determined based on at least one of the changing rate of the channel status or the moving speed of the first device 110. A faster moving UE may request a larger GNSS measurement period to update the GNSS measurement, while a slower moving UE may request a smaller GNSS measurement period to update the GNSS measurement.

In some example embodiments, the starting position or offset of the window requested by the first device 110 may be determined based on the system frame number, so as to align the measurement of the first device 110.

In some example embodiments, the starting position or offset of the window may be determined based on the reporting time of the first device 110. For example, an earlier reporting time may result in a smaller offset in the GNSS measurement window.

In some example embodiments, the starting position or offset of the window may be determined based on the last starting or end position of GNSS measurement. For example, in a case where the first device 110 has a closer GNSS measurement, the offset of the window may be determined to be a larger value so as to avoid a frequent GNSS measurement.

The first device 110 then transmits 215 the first message to the second device 120. The first message may indicate a first configuration of a window for satellite positioning. The first message may be a MAC control element (CE) or a RRC CE transmitted in an uplink channel.

In some example embodiments, the first device 110 may determine that a changing rate of the channel characteristics exceeds a changing rate threshold, or alternatively, the channel characteristic exceeds a threshold of channel characteristics. Along with a change of the channel status, the configuration of the window for satellite positioning required by the first device 110 may also need to be adjusted. In these cases, the first device 110 may determine the first configuration of the window.

In some other example embodiments, the first device 110 may determine that the moving speed of the first device 110 exceeds a speed threshold. Along with the movement of the first device 110, the channel status may also change, which in turn impacts the configuration of the window for satellite positioning required by the first device 110. In this case, the first device 110 may determine the first configuration of the window.

In the above embodiments, the changing rate threshold, the threshold of channel characteristics, and the speed threshold may be configured by the second device 120 or predefined at the first device 110, respectively.

The first message may include the first configuration, or alternatively an indicator of the first configuration. For example, the first device 110 may report the determined maximum GNSS measurement time for each GNSS measurement requested by the first device, e.g., 50 ms, 100 ms, 500 ms, 1s, 2s, or 5s, as the GNSS measurement window to the second device 120 in the first message. For another example, the first device 110 may report the threshold that is close to the GNSS channel quality and used by the first device 110 to select the GNSS measurement window in the first message.

In some example embodiments, a frequency for the first device 110 to transmit the first message may depend on a change of channel characteristics of the first channel 101. In some other example embodiments, the frequency for transmission of the first message may be configured by the second device 120 or predefined at the first device 110 and the second device 120.

Upon receipt of the first message, the second device 120 may determine 220 a second configuration of the window for satellite poisoning based on the first configuration. As such, the second device 120 may further refine the configuration of the window in consideration of the measurement capability of the first device 110, the channel status experienced by the first device 110, the moving speed of the first device 110, and so on.

In the above case, the second device 120 may transmit 225 a second message for indicating the second configuration to the first device 110. It should be understood that, in some cases, the second device 120 may not further determine and transmit the second configuration to the first device 110, and the first device 110 and the second device 120 may communicate with each other based on the first configuration of the window. In other words, the second configuration is not necessary for the process 200.

The GNSS measurement window may correspond to a set of resources dynamically scheduled, semi-statically scheduled or configured granted by the second device 120.

The first device 110 and the second device 120 communicate 230 with each other based on the window determined according to the first configuration. With the precise knowledge of the configuration, the first device 110 and the second device 120 may determine an effective time for communication, such as, a time duration with a fixed distance or gap after the transmission of GNSS measurement from the first device 110.

As such, the first device 110 and the second device 120 may avoid performing data transmissions during the GNSS measurement window. For example, the first device 110 may transmit data to the second device 120 at a first time duration not overlapping with the window. Additionally or alternatively, the first device 110 may receive data from the second device 120 at a second time duration not overlapping with the window.

The first device 110 may measure 235 a GNSS signal during the GNSS measurement window. The first device 110 may then transmit 240 a measurement report for satellite positioning to the second device 120.

It should be understood that the steps and related functions described in process 200 are in no absolute chronological order, and some of the steps may be performed simultaneously or in an order differing from the given one. For example, step 235 may occur before step 230. Other functions can also be executed between the steps or within the steps. Some of the steps can also be left out or replaced with a corresponding step. The present disclosure is not limited in this regard.

According to the example embodiments of the present disclosure, the satellite positioning measurement window can be adjusted based on the environmental factors and the terminal device's factors. Further, since the configuration of the measurement window is updated in a flexible and dynamic manner at both the terminal device and the serving base station, the UL and DL transmissions can be improved in terms of reliability, latency, signaling overhead, and so on.

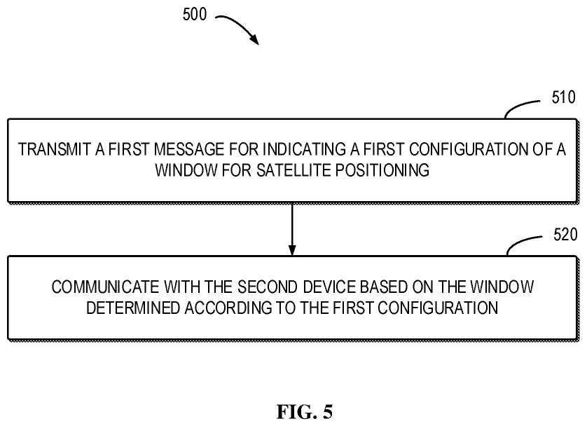

FIG. 5 illustrates a flowchart of an example method 500 of satellite positioning measurement according to some example embodiments of the present disclosure. The method 500 can be implemented at a terminal device, e.g., the first device 110 described with reference to FIG. 1. For the purpose of discussion, the method 500 will be described with reference to FIG. 1.

At 510, the first device 110 transmits a first message to the second device 120 serving the first device 110. The first message may indicate a first configuration of a window for satellite positioning. The window may be at least one of a GNSS measurement window for the first device 110 to measure a GNSS signal, or a reading window for position information of a satellite through which the first device 110 communicates with the second device 120.

In some example embodiments, the first message may include the first configuration. In some other example embodiments, the first message may include an indicator of the first configuration, and the indicator may indicate an index of the first configuration or a channel characteristics value measured by the first device 110 or channel characteristics threshold for determining the first configuration. In these embodiments, the index or the channel characteristics threshold is known to the second device 120.

The first configuration may include, but not limited to, at least one of a window size, an offset, a periodicity or a starting time of the window required by the first device for acquiring position information.

The window size may be, for example, a maximum window size requested by the first device 110. The periodicity may be the minimum periodicity requested by the first device 110. The present disclosure is not limited to this regard.

In some example embodiments, the first configuration may be determined based on at least one of a capability of the first device 110 to acquire position information, a channel status of a channel experienced by the first device 110 and so on. For example, the channel may be a first channel between the first device 110 and the first NTN device 130 that provides positioning information. For another example, the channel may be a second channel between the first device 110 and the second device 120.

In some example embodiments, the channel status may include at least one of a propagation delay of a signal transmitted in the channel, the doppler shift of signal transmitted the channel, at least one parameter indicating a quality of the channel or a changing rate of the channel.

For example, a higher changing rate of the first channel 101 may cause the first device 110 to require a larger GNSS measurement period to update the GNSS measurement. While a lower changing rate of the first channel 101 may cause the first device 110 to require a smaller GNSS measurement period to update the GNSS measurement.

In some example embodiments, the first configuration may be determined further based on at least one of a moving speed of the first device 110, a system frame number received from the second device 120, a time for last transmission of the first message, a starting or end position of a last window for satellite positioning and so on.

In some example embodiments, the first device 110 may determine, from a set of candidate configurations of the window, the first configuration. The set of candidate configurations may be received from the second device 120, or alternatively predefined at the first device 110 and the second device 120.

The set of candidate configurations may include at least one of candidate window sizes, candidate periodicities, candidate offsets, or candidate starting times of the window.

In some example embodiments, the first device 110 may determine that a changing rate of the channel characteristics exceeds a changing rate threshold. In some other example embodiments, the first device 110 may determine that the channel characteristic exceeds a threshold of channel characteristics. In the above embodiments, the first device 110 may then determine the first configuration of the window. The changing rate threshold and the threshold of channel characteristics may be either configured by the second device 120, or predefined at the first device 110.

In some example embodiments, the first device 110 may determinate that a moving speed of the first device 110 exceeds a speed threshold. In this case, the first device 110 may determine the first configuration of the window. The speed threshold may be either configured by the second device 120, or predefined at the first device 110.

In some example embodiments, a frequency for the first device 110 to transmit the first message may be based on a change of a channel characteristic of a channel between the first device 110 and the first NTN device 130 that provides the positioning information. In some other example embodiments, the frequency for the first device 110 to transmit the first message may be configured by the second device 120, or alternatively predefined at the first device 110 and the second device 120.

At 520, the first device 110 communicates with the second device 120 based on the window determined according to the first configuration.

In some example embodiments, the first device 110 may receive a second message for indicating a second configuration of the window from the second device 120. In these embodiments, the first device 110 may communicate with the second device 120 based on the window of the second configuration.

The window of the second configuration may correspond to a set of resources dynamically scheduled, semi-statically scheduled, or configured granted by the second device 120.

In some example embodiments, the first device 110 may transmit data to the second device 120 at a first time duration not overlapping with the window. Additionally, or alternatively, the first device 110 may receive data from the second device 120 at a second time duration not overlapping with the window.

In some example embodiments, the first device 110 may determine satellite positioning information within the window, and transmit a measurement report for satellite positioning to the second device 120.

According to the example embodiments of the present disclosure, there is provided an enhanced mechanism for configuring satellite positioning measurement window. The satellite positioning measurement window can be dynamically and flexibly configured at the terminal device in consideration of the measurement capability, the moving speed, the channel status and so on. Further, the terminal device and its serving the base station are aware of the configuration of the measurement window at a low signaling overhead. As such, the requirement on power consumption, reliability and latency for the terminal devices can be satisfied.

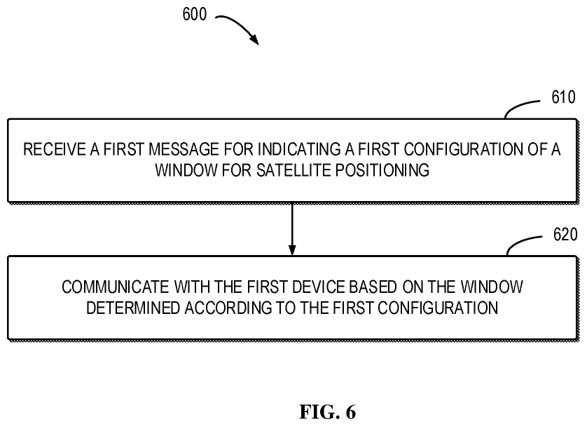

FIG. 6 illustrates a flowchart of an example method 600 of satellite positioning measurement according to some example embodiments of the present disclosure. The method 600 can be implemented at a network device, e.g., the second device 120 described with reference to FIG. 2. For the purpose of discussion, the method 600 will be described with reference to FIG. 2.

At 610, the second device 120 receives a first message from the first device 110. The first message indicates a first configuration of a window for satellite positioning.

The first message may include the first configuration, or alternatively an indicator of the first configuration. For example, the indicator may indicate an index of the first configuration or a channel characteristics value measured by the first device 110 or channel characteristics threshold for determining the first configuration. In this case, the index or the channel characteristics threshold is known to both the first device 110 and the second device 120.

The first configuration may include at least one of a window size, an offset, a periodicity or a starting time of the window required by the first device for acquiring position information. For example, the window size may be a maximum window size requested by the first device 110. For another example, the periodicity may be a minimum periodicity requested by the first device 110. The present disclosure is not limited in this regard.

In some example embodiments, the first configuration may be determined by the first device 110 from a set of candidate configurations. The set of candidate configurations of the window may be configured by the second device 120, or alternatively, predefined at the first device 110 and the second device 120.

In some example embodiments, the set of candidate configurations may include at least one of candidate window sizes, candidate periodicities, candidate offsets, candidate starting times of the window.

At 620, the second device 120 communicates with the first device 110 based on the window determined according to the first configuration.

In some example embodiments, upon receipt of the first message, the second device 120 may transmit a second message for indicating a second configuration of the window to the first device 110. In this case, the second device 120 may communicate with the second device based on the window of the second configuration.

In some example embodiments, the second device 120 may allocate a set of resources for the measurement window to the first device 110. The set of resources may be dynamically scheduled, semi-statically scheduled, or configured granted by the second device 120.

In some example embodiments, communication between the first device 110 and the second device 120 may be prohibited during the window. For example, the second device 120 may receive data from the first device 110 at a first time duration not overlapping with the window. Additionally, or alternatively, the second device 120 may transmit data to the first device 110 at a second time duration not overlapping with the window.

According to example embodiments of the present disclosure, there is provided an enhanced mechanism for configuring satellite positioning measurement window. In this mechanism, the satellite positioning measurement window can be determined based on the measurement capability, the moving speed of the terminal device and the varying channel status. Moreover, the configuration of the window for satellite positioning can be aligned between the terminal device and the base station with a low signaling overhead.

In some example embodiments, a first apparatus capable of performing the method 500 (for example, the first device 110) may comprise means for performing the respective steps of the method 500. The means may be implemented in any suitable form. For example, the means may be implemented in a circuitry or software module. The first apparatus may be implemented as or included in the first device 110. In some embodiments, the means may comprise at least one processor and at least one memory including computer program code. The at least one memory and computer program code are configured to, with the at least one processor, cause performance of the first apparatus.

In some example embodiments, the first apparatus comprises: means for transmitting, to a second device serving the first apparatus, a first message for indicating a first configuration of a window for satellite positioning; and means for communicating with the second device based on the window determined according to the first configuration.

In some example embodiments, the first apparatus further comprises: means for determining, from a set of candidate configurations of the window, the first configuration, the set of candidate configurations received from the second device or predefined at the first apparatus.

In some example embodiments, the set of candidate configurations comprises at least one of a candidate window size, a candidate periodicity, a candidate offset, a candidate starting time of the window.

In some example embodiments, the first configuration is determined based on at least one of: a capability of the first apparatus to acquire position information, or a channel status of a channel experienced by the first apparatus.

In some example embodiments, the first configuration is determined further based on at least one of a moving speed of the first apparatus, a system frame number received from the second device, a time for last transmission of the first message, a starting or end position of a last window for satellite positioning.

In some example embodiments, the channel comprises at least one of a first channel between the first apparatus and a satellite that providing positioning information or a second channel between the first apparatus and the second device.

In some example embodiments, the channel status comprises at least one of a propagation delay of a signal transmitted in the channel, the doppler shift of signal transmitted the channel, at least one parameter indicating a quality of the channel or a changing rate of the channel.

In some example embodiments, the first apparatus further comprises: means for in accordance with a determination that a changing rate of the channel characteristics exceeds a changing rate threshold or the channel characteristics exceeds a threshold of channel characteristics, determining the first configuration of the window, the changing rate threshold and the threshold of channel characteristics configured by the second device or predefined at the first apparatus.

In some example embodiments, the first apparatus further comprises: means for in accordance with a determination that a moving speed of the first apparatus exceeds a speed threshold, determining the first configuration of the window, the speed threshold configured by the second device or predefined at the first apparatus.

In some example embodiments, the first configuration comprises at least one of a window size, an offset, a periodicity or a starting time of the window required by the first apparatus for acquiring position information.

In some example embodiments, the window size is a maximum window size requested by the first apparatus and/or the periodicity is the requested minimum periodicity.

In some example embodiments, the first message comprises one of the first configuration, or an indicator of the first configuration.

In some example embodiments, the indicator indicates an index of the first configuration or a channel characteristic value measured by the first device or a channel characteristic threshold for determining the first configuration, the index or the channel characteristics threshold known in the second device.

In some example embodiments, a frequency to transmit the first message for the first apparatus is based on a change of a channel characteristic of a channel between the first apparatus and a satellite providing positioning information, or configured by the second device or predefined at the first apparatus and the second device.

In some example embodiments, the means for communicating with the second device comprises: means for receiving, from the second device, a second message for indicating a second configuration of the window; and means for communicating with the second device based on the window of the second configuration.

In some example embodiments, the window of the second configuration corresponds to a set of resources dynamically scheduled, semi-statically scheduled, or configured granted by the second device.

In some example embodiments, the means for communicating with the second device comprises at least one of: means for transmitting data to the second device at a first time duration not overlapping with the window; or means for receiving data from the second device at a second time duration not overlapping with the window.

In some example embodiments, the first apparatus further comprises: means for determining satellite positioning information within the window; and means for transmitting a measurement report for satellite positioning to the second device.

In some example embodiments, the window comprises at least one of a global navigation satellite system, GNSS, measurement window for the first apparatus to measure a GNSS signal, or a reading window for position information of a satellite through which the first device communicates with the second device.

In some example embodiments, the first apparatus comprises a terminal device and the second device comprises a network device.

In some example embodiments, a second apparatus capable of performing the method 600 (for example, the second device 120) may comprise means for performing the respective steps of the method 600. The means may be implemented in any suitable form. For example, the means may be implemented in a circuitry or software module. In some embodiments, the means may comprise at least one processor and at least one memory including computer program code. The at least one memory and computer program code are configured to, with the at least one processor, cause performance of the second apparatus. The second apparatus may be implemented as or included in the second device 120.

In some example embodiments, the second apparatus comprises: means for receiving, from a first device, a first message for indicating a first configuration of a window for satellite positioning; and means for communicating with the first device based on the window determined according to the first configuration.

In some example embodiments, the first configuration is determined from a set of candidate configurations of the window configured by the second apparatus or predefined at the first device and the second apparatus.

In some example embodiments, the set of candidate configurations comprises at least one of candidate window sizes, candidate periodicities, candidate offsets, candidate starting times of the window.

In some example embodiments, the first configuration comprises at least one of a window size, an offset, a periodicity or a starting time of the window required by the first device for acquiring position information.

In some example embodiments, the window size is a maximum window size requested by the first device and/or the periodicity is a minimum periodicity requested by the first device.

In some example embodiments, the first message comprises one of the first configuration, or an indicator of the first configuration.

In some example embodiments, the indicator indicates an index of the first configuration or a channel characteristics value measured by the first device 110 or channel characteristics threshold for determining the first configuration, the index or the channel characteristics threshold known to the second apparatus.

In some example embodiments, the means for communicating with the first device comprises: means for transmitting a second message for indicating a second configuration of the window to the first device; and means for communicating with the first apparatus based on the window of the second configuration.

In some example embodiments, the second apparatus further comprises: means for allocating, to the first device, a set of resources for the measurement window, the set of resources dynamically scheduled, semi-statically scheduled, or configured granted by the second apparatus.

In some example embodiments, the means for communicating with the first device comprises at least one of the following: means for receiving data from the first device at a first time duration not overlapping with the window; or means for transmitting data to the first device at a second time duration not overlapping with the window.

In some example embodiments, the first device comprises a terminal device, and the second apparatus comprises a network device.

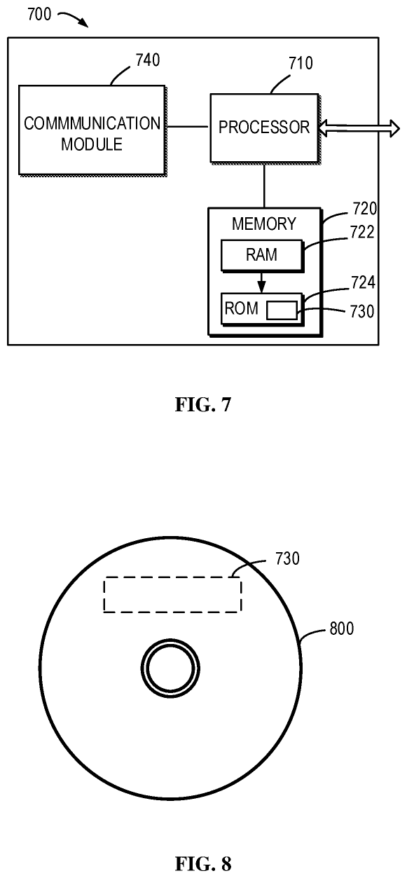

FIG. 7 is a simplified block diagram of a device 700 that is suitable for implementing embodiments of the present disclosure. The device 700 may be provided to implement the communication device, for example the terminal device 110, or the network device 120 as shown in FIG. 2. As shown, the device 700 includes one or more processors 710, one or more memories 720 coupled to the processor 710, and one or more transmitters and receivers (TX/RX) 740 coupled to the processor 710.

The TX/RX 740 is for bidirectional communications. The TX/RX 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 720. The processor 710 may perform any suitable actions and processing by loading the program 730 into the RAM 720.

The embodiments of the present disclosure may be implemented by means of the program 730 so that the device 700 may perform any process of the disclosure as discussed with reference to FIGS. 3, 5 and 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the methods 500 and 600 as described above with reference to FIGS. 5-6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-36. (canceled)

37. A terminal device comprising:
at least one processor; and
at least one memory including computer program code;
wherein the at least one memory and the computer program code are configured to, with the at least one processor, cause the terminal device to:
determine a first configuration of a measurement window for satellite positioning;
transmit, to a network device serving the terminal device, a first message for indicating the first configuration of the measurement window for satellite positioning;
measure a satellite positioning signal within the window, and
transmit a measurement report for satellite positioning to the network device,
wherein the terminal device and the network device communicate avoiding performing data transmissions during the measurement window.

38. The terminal device of claim 37, wherein the at least one memory and the computer program code are configured to, with the at least one processor, further cause the terminal device to:
determine, from a set of candidate configurations of the window, the first configuration, the set of candidate configurations received from the network device or predefined at the terminal device.

39. The first device of claim 37, wherein the at least one memory and the computer program code are configured to, with the at least one processor, further cause the terminal device to:
determine, from a set of candidate configurations of the window, the first configuration, the set of candidate configurations received from the network device or predefined at the terminal device, and wherein the set of candidate configurations comprises at least one of a candidate window size, a candidate periodicity, a candidate offset, a candidate starting time of the window.

40. The first device of claim 37, wherein the first configuration is determined based on at least one of:
a capability of the terminal device to acquire position information, a channel status of a channel experienced by the terminal device, a moving speed of the terminal device, a system frame number received from the network device, a time for last transmission of the first message, a starting or end position of a last window for satellite positioning.

41. The first device of claim 40, wherein the first configuration is determined based on at least one of: a capability of the terminal device to acquire position information, a channel status of a channel experienced by the terminal device, moving speed of the terminal device, a system frame number received from the network device, a time for last transmission of the first message, a starting or end position of a last window for satellite positioning, the terminal device further being caused to:
in accordance with a determination that a changing rate of the channel characteristics exceeds a changing rate threshold or the channel characteristics exceeds a threshold of channel characteristics, determine the first configuration of the window, the changing rate threshold and the threshold of channel characteristics configured by the network device or predefined at the terminal device.

42. The first device of claim 40, the first configuration is determined based on at least one of: a capability of the terminal device to acquire position information, a channel status of a channel experienced by the terminal device, moving speed of the terminal device, a system frame number received from the network device, a time for last transmission of the first message, a starting or end position of a last window for satellite positioning, the terminal device further being caused to:
in accordance with a determination that a moving speed of the terminal device exceeds a speed threshold, determine the first configuration of the window, the speed threshold configured by the network device or predefined at the terminal device.

43. The terminal device of claim 37, wherein the first configuration comprises at least one of a window size, an offset, a periodicity or a starting time of the window required by the terminal device for acquiring position information.

44. The terminal device of claim 37, wherein the first configuration comprises at least one of a window size, an offset, a periodicity or a starting time of the window required by the terminal device for acquiring position information, and wherein the window size is a maximum window size requested by the terminal device and/or the periodicity is the requested minimum periodicity.

45. The terminal device of claim 37, wherein the first message comprises one of the first configuration, or an indicator of the first configuration.

46. The first device of claim 37, wherein a frequency for the terminal device to transmit the first message is based on a change of a channel characteristics of a channel between the terminal device and a satellite providing positioning information, or configured by the network device or predefined at the terminal device and the network device.

47. The first device of claim 37, wherein the avoiding performing data transmissions during the measurement window comprises:
transmitting data to the second device at a first time duration not overlapping with the window; or
receiving data from the second device at a second time duration not overlapping with the window.

48. A method comprising:
determining a first configuration for a measurement window for satellite positioning;
transmitting, by a terminal device to a network device serving the terminal device, a first message for indicating a first configuration of the measurement window for satellite positioning;
measuring a satellite positioning signal within the window, and
transmitting a measurement report for satellite positioning to the network device, wherein the terminal device and the network device communicate avoiding performing data transmission during the measurement window.
